(19) United States
(12) Patent Application Publication
(10) Pub. No.: US 2007/0283301 A1
(43) Pub. Date: Dec. 6, 2007

(54) System and Method of Eliminating Electrical Violations

(76) Inventors: Arvind K. Karandikar, Austin, TX (US); Charles J. Alpert, Cedar Park, TX (US); Mehmet C. Yildiz, Austin, TX (US); Stephen T. Quay, Austin, TX (US); Tuhin Mahmud, Austin, TX (US); Paul G. Villarrubia, Austin, TX (US)

Correspondence Address: Frank C. Nicholas;CARDINAL LAW GROUP, Suite 2000, 1603 Orrington Avenue, Evanston, IL, 60201, US

(21) Appl. No.: 11/422,174

(22) Filed: Jun. 5, 2006

(51) Int. Cl. G06F 17/50; G06F 9/45

(52) U.S. Cl. 716/5; 716/2

(57) ABSTRACT

A system and method for correcting electrical violations, the method including examining a plurality of nets for at least one electrical violation in a sequential order of a first output-to-input traversal, and determining a net correction in each net of the plurality of nets having an electrical violation prior to examining a next net in the sequential order of the first output-to-input traversal.

### TECHNICAL FIELD

The technical field of this disclosure is integrated circuit design, particularly, identifying and eliminating electrical violations in integrated circuit designs.

### BACKGROUND OF THE INVENTION

Before an integrated circuit can be fabricated, electrical violations in the design must be fixed, i.e., the design must meet certain constraints. Examples of electrical violations include slew limits, capacitance limits, and fanout limits. The principal approaches to fixing electrical violations in a net are resizing the source of the net and/or adding buffers to the net. Current integrated circuit design methodologies focus on optimizing the delay, area, or power of the design.

While the requirement that a circuit must be electrically clean (free of electrical violations) is significant to the design process, little has been done to provide an efficient method of electrical violation correction. Methods used to optimize delay are used to fix electrical violations, instead. This leads to expensive solutions for electrical violations, because the method employed is designed to solve a different problem. Delay optimization methods require more valuable silicon area than would a solution specifically tailored to the eliminating the electrical violations. Even with this expensive solution, many electrical violations remain unfixed.

FIG. 1 is a flow chart of an iterative approach presently used to correct electrical violations. The iterative approach 100 begins by pre-selecting a single net correction prior to an iterative run 102. Once a single pre-selected net correction is pre-selected, a net is examined for electrical violations 104. When no electrical violation exists 106, the program proceeds to another net 110. When an electrical violation exists 106, the program attempts to correct the electrical violation by applying the pre-selected net correction 108. The pre-selected net correction may or may not correct the electrical violation, and can introduce additional electrical violations, unnecessary area, or other problems to the net. After this pre-selected net correction has been applied 108, the program proceeds to another net 110 when the net was not the last net 112. When the net was the last net 112 and there was an electrical violation 114, the process is repeated through the circuit by selecting another pre-selected net correction 102. When there was no electrical violation 114, the process ends.

The first net correction pre-selected and applied to fix any encountered electrical violations is usually gate resizing. This gate resizing is not timing driven, but tries to match the correct gate size with the load being driven. The best gate size is determined given the input slew, output load, and the required output slew. Since nets with electrical violations are considered here, gates are typically sized up. Larger gates have greater drive capabilities and can drive larger loads. However, this results in an increased capacitance at the inputs of the sized gates and can introduce new electrical violations at the inputs. Electrical violations exist that even the largest gate sizes available will not fix. Therefore, iterative passes employing only gate resizing can leave electrical violations unsolved.

The second net correction is generally pre-selected and applied to fix the remaining electrical violations is buffer insertion. Application of this net correction requires a new iterative pass over the circuit. To conserve runtime, the most aggressive buffering algorithms are generally not used, which can lead to electrical violations remaining unfixed. When there are loops in the circuit, fixing electrical violations on one net can lead to new electrical violations on nets that were fixed previously. Repeated iterations of resizing and buffering are employed to address these remaining electrical violations.

Subsequent net corrections can be made more aggressive, in the hope that the remaining electrical violations can be fixed. The process iterates until either all electrical violations are fixed or the runtime becomes excessive. For example, one pass of gate resizing with certain threshold settings can determine that gate resizing is an inappropriate correction and leave the correction for another iterative pass. In the next iterative pass of buffering, however, there can be conditions, such as blockages, that prohibit the insertion of buffers. Subsequent passes of resizing and buffering with different settings can overcome this situation, and there is no guarantee that any of these passes will fix the electrical violation.

A major problem with the iterative approach is that sizing and buffering are applied sequentially to fix electrical violations, with no communication or cooperation between passes. Each pass of resizing or buffering tries to fix the electrical violations that it sees, and assumes that the next pass will be able to handle the electrical violations that it cannot fix.

There is therefore a need for an area-efficient strategy that targets the electrical state of a circuit and fixes all electrical violations quickly. It would be desirable to have a system and method of eliminating electrical violations that would overcome the above disadvantages.

### SUMMARY OF THE INVENTION

The system and method of eliminating electrical violations of the present invention combines an output-to-input circuit traversal with multiple net correction options to determine one or more net corrections to be applied on a net-by-net basis. This method efficiently eliminates electrical violations.

One aspect of the present invention provides a method for correcting electrical violations including examining a plurality of nets for at least one electrical violation in a sequential order of a first output-to-input traversal, and determining a net correction in each net of the plurality of nets having an electrical violation prior to examining a next net in the sequential order of the first output-to-input traversal.

Another aspect of the present invention provides an information handling system including a processor, a memory coupled to said processor to store instructions executable by a digital processing apparatus to perform operations to correct electrical violations. The operations include examining a plurality of nets for at least one electrical violation in a sequential order of a first output-to-input traversal, and determining a net correction in each net of the plurality of nets having an electrical violation prior to examining a next net in the sequential order of the first output-to-input traversal.

Another aspect of the present invention provides a computer program product in a computer usable medium for correcting electrical violations including computer program code for examining a plurality of nets for at least one electrical violation in a sequential order of a first output-to-input traversal, computer program code for determining a net correction in each net of the plurality of nets having an electrical violation prior to examining a next net in the sequential order of the first output-to-input traversal.

The foregoing and other features and advantages of the invention will become further apparent from the following detailed description of the presently preferred embodiments, read in conjunction with the accompanying drawings. The detailed description and drawings are merely illustrative of the invention, rather than limiting the scope of the invention being defined by the appended claims and equivalents thereof.

### BRIEF DESCRIPTION OF THE DRAWINGS

FIG. 1 is a flowchart of a method for eliminating electrical violations, as known in the art;

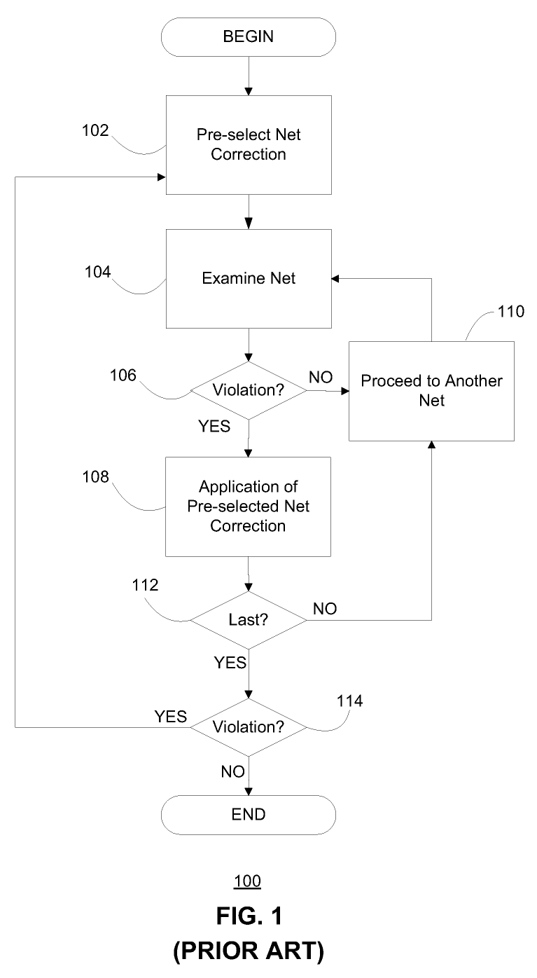

FIG. 2 is a flowchart of determining net corrections for each of a plurality of nets in a method for correcting electrical violations in accordance with the present invention;

FIG. 3 is a flowchart of preferred selection of net corrections in a method for correcting electrical violations in accordance with the present invention;

FIG. 4 is a flowchart of eliminating electrical violations in a method for correcting electrical violations in accordance with the present invention;

FIG. 5 is a flowchart of a method for correcting electrical violations in accordance with the present invention; and

FIG. 6 is a block diagram of an information handling system for eliminating electrical violations in accordance with the present invention.

### DESCRIPTION OF A PREFERRED EMBODIMENT

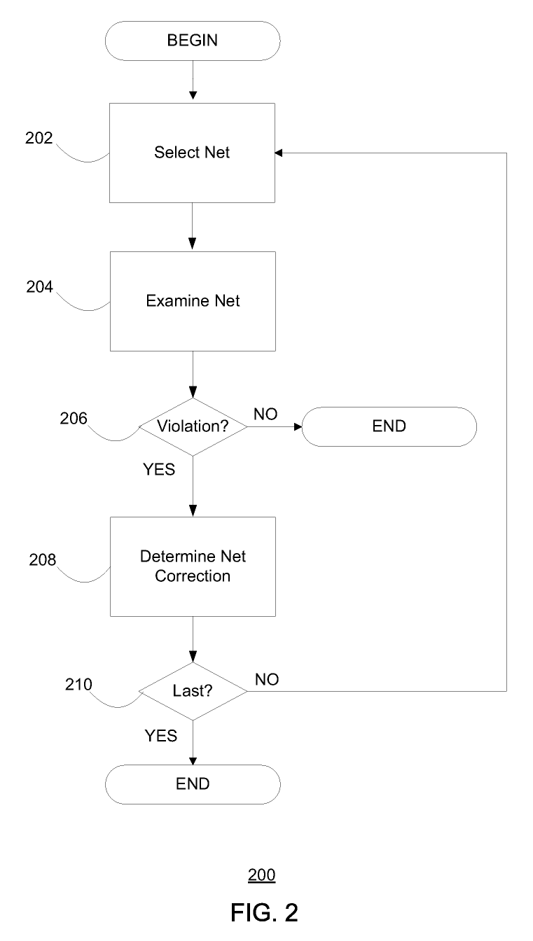

FIG. 2 is a flowchart of determining net corrections for each of a plurality of nets in a method for correcting electrical violations in accordance with the present invention. In this embodiment, net corrections are determined when there are electrical violations in an output-to-input traversal, but the net corrections need not be applied.

The method 200 includes selecting a net 202, and examining the net 204 for at least one electrical violation. When the net does not contain an electrical violation 206, the method ends. When the net does contain an electrical violation 206, the system determines a net correction 208. When the net was not the last net 210, a next net can be selected 202. When the net was the last net 210, the method 200 ends. The selecting a net 202 includes selecting nets in a circuit in a sequential order of an output-to-input traversal of the nets. The method 200 determines a net correction for each of the nets having an electrical violation prior to examining a next net in the sequential order of the output-to-input traversal. The determining a net correction 208 includes selecting among multiple available net corrections, allowing for the use of the multiple net corrections in a single pass over the design.

The examining the net 204 includes examining the net as modeled against design limits and identifying any electrical violations. During modeling, timing analyzers may be forced to operate outside the characterized values of parameters for gates, such as delays, slews, maximum capacitive load, and maximum input slew rate. The timing analyzer then extrapolates best guess values, which may be incorrect and give rise to electrical violations.

There are three types of electrical violations: slew limit violations, capacitance limit violations, and fanout limit violations. Slew limits define the maximum slews permissible on all the nets of a design. If the slew at the input of a logic gate is too long, a gate may not switch at the target speed, or may not switch at all, leading to incorrect operation. Capacitance limits define the maximum effective capacitance that a gate or an input pin can drive. A large capacitance on the output of a gate directly affects its switching speed and power dissipation. Additionally, gates are typically characterized for a limited range of output capacitance, and delay calculation during design may be incorrect if the output capacitance is greater than the maximum value. Fanout limits define the number of fanouts that can be driven by different gates. Critical nets may be limited to a lower number of fanouts.

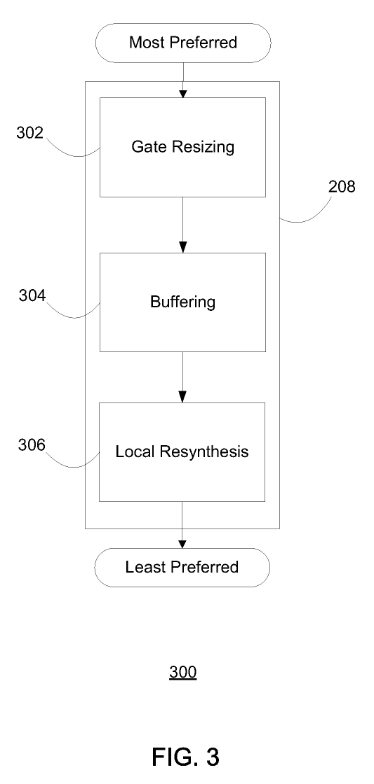

FIG. 3 is a flowchart of preferred selection of net corrections in a method for correcting electrical violations in accordance with the present invention. Determining a net correction 206 is defined herein as selecting one or more net correction from a group of possible net corrections. In one embodiment, the selection of a net correction from a group of possible net corrections is done in a preferential order. The determining a net correction 206 is based on a preferred ordering. The method 300 is executed when an electrical violation is encountered. First, gate resizing is reviewed for suitability as a net correction 302. Next, The application of buffering is reviewed for suitability 304. Finally, local resynthesis is reviewed for suitability 306.

In one embodiment, the gate resizing 302 fixes slew and capacitance violations that are encountered. Gate resizing is not timing driven and a gate can be resized based on the load driven. A gate resizing may be selected, for example, based on input slew, output load, and the required output slew. Larger gates have greater drive capabilities, and therefore can drive larger loads.

In one embodiment, the application of buffering 304 provides buffering between one net and another. A buffer amplifier can be used to transfer a voltage from a first net, having a high impedance level, to a second net with a lower impedance level. The interposed buffer amplifier prevents the second net from loading the first net unacceptably and interfering with its desired operation.

In one embodiment, the local resynthesis 306 includes a variety of analyses on the logic in a net. The logic may be supported by a variety of net layouts. Local resynthesis may include the selection of an alternate net layout.

A net correction may include multiple net corrections. For example, both gate resizing and buffering can be selected as a single net correction. Determining net corrections 206 in a single output-to-input traversal may include determining a net correction based on the individual net being examined 202 and the preferred selection of net corrections method 300.

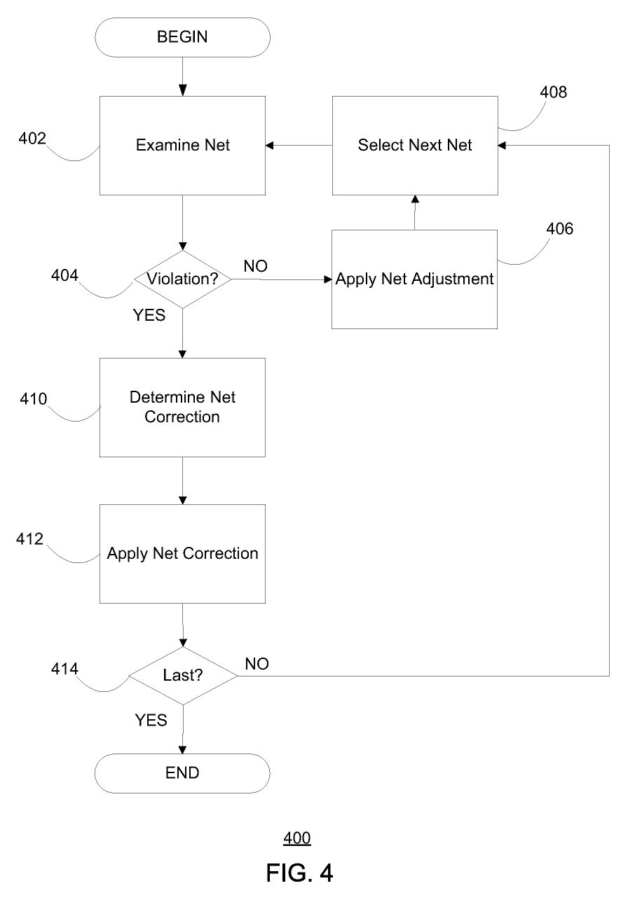

FIG. 4 is a flowchart of eliminating electrical violations in a method for correcting electrical violations in accordance with the present invention. In this embodiment, net adjustments and/or net corrections are determined in an output-to-input traversal, and the net adjustments and/or net corrections are applied to one net before proceeding to the next net upstream.

The method 400 examines a net for electrical violations 402. A number of nets are examined for at least one electrical violation in a sequential order of an output-to-input traversal. The examination identifies whether the net contains an electrical violation 404. If there are no electrical violations on the net, a net adjustment can be applied 406. The process can then select the next net 408, for example the next net in output-to-input order. If an electrical violation does exist on the net, a net correction is determined 410. A net correction is determined for each net of the plurality of nets having an electrical violation prior to examining a next net in the sequential order of the output-to-input traversal. The net correction can then be applied 412. When the net was not the last net 414, a next net can be selected 408. When the net was the last net 414, the method 400 ends.

Exemplary net adjustments that can be applied to nets 406 include sizing down the source or driving gate, or making no change to the net. The gate can be sized down as much as possible without introducing a new electrical violation. This recovers area when the gates are larger than necessary. The recovered area can be used for improving delay on critical paths of the circuit through the application of additional buffering. In addition, reducing the load on input nets potentially removes electrical violations that can exist or reduces their severity.

Selecting the next net 408 includes selecting nets in a sequential order during an output-to-input traversal. A net that is located at the input of another net is defined herein as being upstream of the second net. By processing nets in upstream order during the output-to-input traversal, any effect of resizing gates only impacts the input nets which are yet to be processed. This avoids introducing new electrical violations into nets in which the electrical violations have already been eliminated.

Those skilled in the art will appreciate that a number of variations in the method 400 are possible, such as inverter ripping up, loop handling, preferred net correction determination, and/or recursive application. Each of these variations is discussed in turn below.

In one embodiment, applying a net correction 412 includes ripping up existing inverters, i.e., deleting existing inverters. In the initial stages of design, a circuit can have a number of inverters that have been added in order to deal with signal polarity requirements. These inverters can be added before there is any plan for the physical layout of the design. For example, a design can add an inverter that drives negative sinks. Once the design has been placed, however, positive and negative polarity sinks may be clustered together. A buffering approach that treats the positive and negative sinks separately will treat this problem as two different instances, with each net being buffered separately. Determining a net correction 410 can include ripping up the inverters the first time a net with inverters is encountered. Ripping up the inverters allows reconfiguring the layout of the inverters on the net based on the net examination 402. For example, once a design has been placed, positive and negative polarity sinks may be clustered too closely together. Ripping up the inverters may allow them to be reconfigured to avoid such design flaws.

In another embodiment, applying a net correction 412 includes handling loops. Many circuits have loops, with registers breaking cycles. This does not create problems in many cases, as registers can be sized in a small range. However, this can lead to the introduction of new electrical violations in a few circuits. Even when processing nets in an upstream output-to-input traversal, applying a correction to one net in a loop can result in an electrical violation on a previously corrected net. In a circuit with loops, a check can be performed to determine whether the inputs of a gate were previously processed each time a gate is sized up. If so, the nets can be examined for new electrical violations that may have been introduced when the gate was sized up. The electrical violations can be fixed before proceeding to the next net. The electrical violation is often small and only a small adjustment to the gate size is required. The inputs of the gate can be resized as well, if necessary.

In another embodiment, determining a net correction 410 includes experimentally determining a preferred net correction. One example is choosing between gate resizing and buffering. If an electrical violation can be fixed by either gate resizing or by buffering, the lowest cost solution, for example, the net correction requiring the least area, may be preferred. This lowest cost solution can be determined experimentally. The gate is resized, the area increase measured, and the gate reset to its original size. Buffering is then applied, the area increase measured, and the net is reset to the initial condition. The lowest cost solution is then selected based on the solution having the smaller associated area increase. Area increase is just one example of a measurement that can be used to determine a preferred net correction. Other comparisons between solutions provided by various net corrections can be considered in determining a preferred net correction. For example, solutions may be selected based on criteria such as minimizing delay, minimizing power consumption, or the like. Those skilled in the art will appreciate that the experimental approach will incur additional runtime for the analysis, and so can be applied to particular net designs as desired.

In another embodiment, the method 400 is applied recursively, i.e., new nets can be created and electrical violations within the new nets eliminated using the method 400. The runtime of method 400 is often dominated by time spent in buffering. The runtime of buffering algorithms increases with the square of the size of the buffer library used. To improve runtime, a small buffer library can be used for the output-to-input traversal according to method 400. When new nets are created, the method 400 may be applied to the new nets individually, correctly sizing newly added buffers. Electrical violations are identified 404 in the new nets and net corrections determined 410 during an output-to-input traversal on a net-by-net basis.

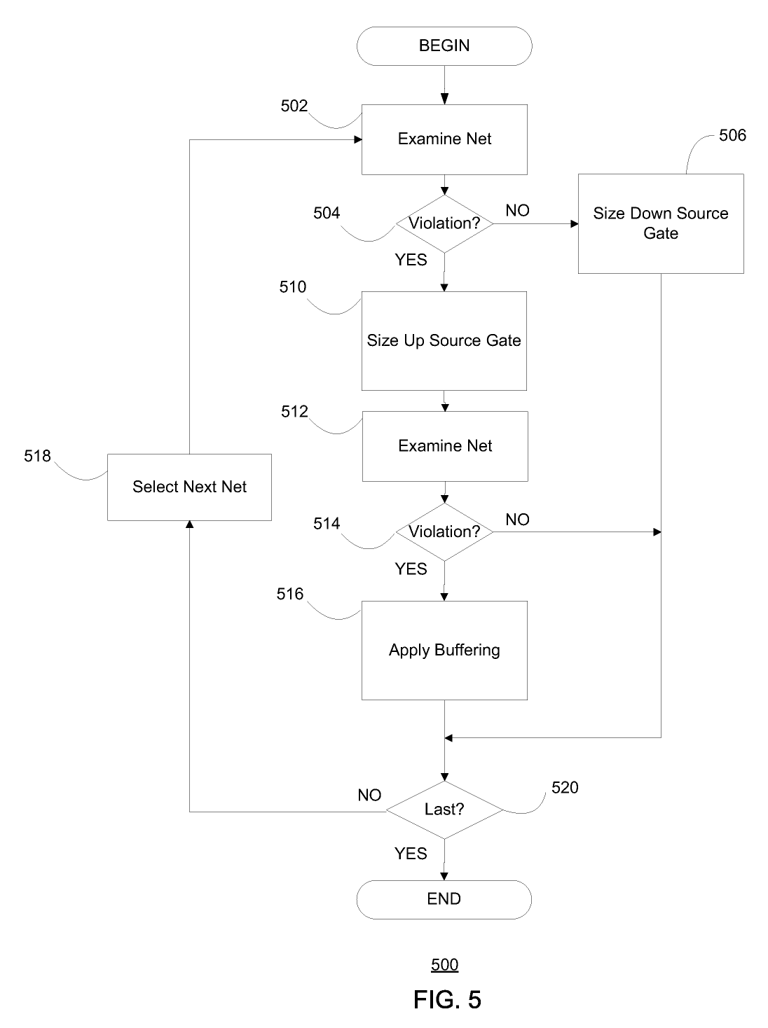

FIG. 5 is a flowchart of a method 500 for correcting electrical violations in accordance with the present invention. In this embodiment, the source gate is sized down when there are no electrical violations and sized up when there are electrical violations. When there are violations after sizing up a source gate, buffering is applied. The method is performed in an output-to-input traversal.

A net is examined for electrical violations 502. When there are no electrical violations on the net 504, the source gate is sized down 506 and the next net is selected 516. When an electrical violation does exist on the net 504, the source gate is sized up 510. The net is examined for electrical violations 512. When no electrical violation is identified 514, the next net is selected 518 when the net was not the last net 520. When an electrical violation is identified 514, buffering is applied to the net 516. When the net was not the last net 520, a next net can be selected 518. When the net was the last net 520, the method 500 ends.

Traversing nets from the output to input nets avoids elimination of electrical violations in one net from affecting a downstream net that has already had electrical violations eliminated. Sizing a source gate up 510 to remove an electrical violation on its output can have a detrimental affect on its input nets. The output-to-input traversal prevents this. In one embodiment, the sizing up a gate 510 includes iterating through available sizes of source gates for a given input slew rate and output load, and selecting the smallest gate size that can deliver the required output slew.

Sizing a source gate down 506 recovers area when the source gate is larger than required. The recovered area can be used for other purposes, such as improving delay on critical paths. In addition, sizing a source gate down 506 may eliminate or reduce the severity of upstream electrical violations by reducing the load on input nets.

Buffering is applied to the net 516 when the source gate resizing fails to eliminate the electrical violations on the net. Buffering is the net correction of last resort, so the buffering can be as aggressive as required. Gate resizing before buffering is also advantageous from a runtime standpoint because buffering is slower than sizing the source gate. In one embodiment, the buffering is applied to the net 516 based on van Ginneken's algorithm. The algorithm selects the minimum buffer solutions such that slew constraints are satisfied. In one example, the buffer library includes one buffer and three inverters. Limiting the buffer library allows resizing the buffer gates because of the lack of granularity. A more fine-grained library can be used, but runtime increases.

Those skilled in the art will appreciate that a number of variations in the method 500 are possible, such as blockage avoidance, minimum perturbation, and/or timer use. Each of these variations is discussed in turn below.

In one embodiment, applying buffering to the net 516 allows for blockage avoidance. The method 500 may not be able to insert buffers when there is no insertion point for buffers, i.e., when there is a blockage. In one embodiment, the applying buffering to the net 516 includes blockage avoidance, such as examining alternate Steiner tree configurations, or the like.

In another embodiment, selecting a next net 518 employs a minimum perturbation mode. As a design nears finalization, certain nets can be at a final version while other nets can still be altered. Optimizations of certain aspects of the design can introduce electrical violations, such as when the placement of gates and buffers is changed. In selecting a next net 518, the selection can be limited to only select nets with electrical violations that can still be altered.

In another embodiment, the examining a net for an electrical violation 502 includes the use of a timer. The timer is used during the examining 502 to determine an actual slew rather than assuming a default slew. The actual slew provides a more accurate analysis of a design. Use of actual slews can increase runtime, however, because each change to a net can require recalculation of the actual slews and arrival times near the change. In one embodiment, the minimum perturbation mode described above is used in combination with the timer, so that actual slews are calculated for particular nets.

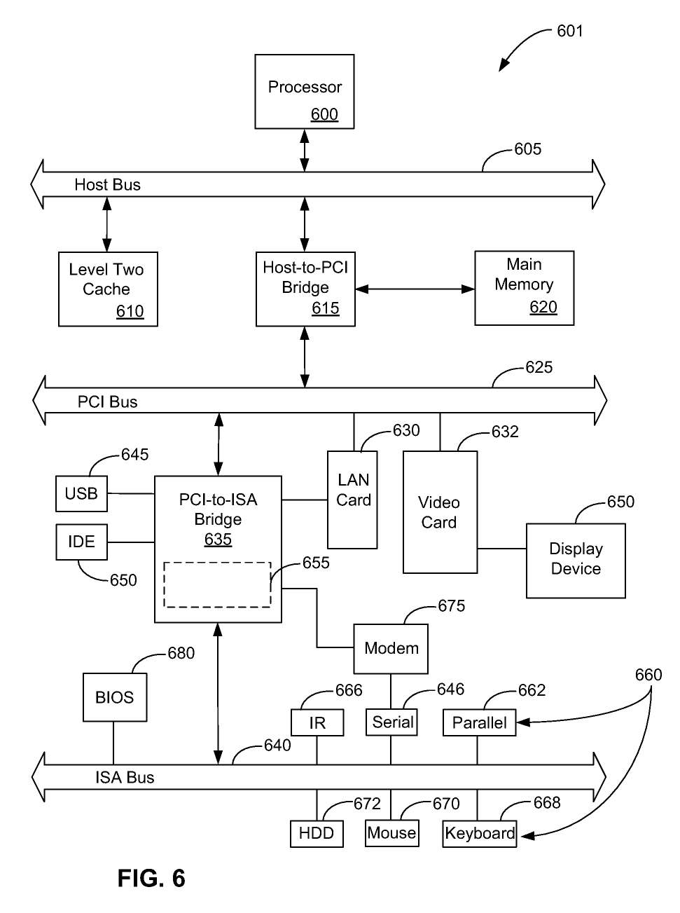

FIG. 6 is a block diagram of an information handling system for eliminating electrical violations in accordance with the present invention. The information handling system 601 is a simplified example of a computer system capable of performing the operations described herein. The information handling system 601 includes processor 600 which is coupled to host bus 605. A level two (L2) cache memory 610 is also coupled to the host bus 605. Host-to-PCI bridge 615 is coupled to main memory 620, includes cache memory and main memory control functions, and provides bus control to handle transfers among PCI bus 625, processor 600, L2 cache 610, main memory 620, and host bus 605. The PCI bus 625 provides an interface for a variety of devices including, for example, LAN card 630 and/or video card 632. The video card 632 is operably connected to a display device 690, such as a liquid crystal display (LCD), a cathode ray tube (CRT) display, a projection display, or the like. The display device 690 can be used for presenting information related to eliminating electrical violations. Those skilled in the art will appreciate that the video card 632 can be attached to other types of busses, such as an AGP or a PCI Express bus, as desired for a particular application.

PCI-to-ISA bridge 635 provides bus control to handle transfers between the PCI bus 625 and ISA bus 640, universal serial bus (USB) functionality 645, IDE device functionality 650, power management functionality 655, and can include other functional elements not shown, such as a real-time clock (RTC), DMA control, interrupt support, and system management bus support. Peripheral devices and input/output (I/O) devices can be attached to various interfaces 660 (e.g., parallel interface 662, serial interface 664, infrared (IR) interface 666, keyboard interface 668, mouse interface 670, and fixed disk (HDD) 672) coupled to ISA bus 640. Alternatively, a super I/O controller (not shown) can be attached to the ISA bus 640 to accommodate many I/O devices.

BIOS 680 is coupled to ISA bus 640, and incorporates the necessary processor executable code for a variety of low-level system functions and system boot functions. The BIOS 680 can be stored in any computer readable medium, including magnetic storage media, optical storage media, flash memory, random access memory, read only memory, and communications media conveying signals encoding the instructions (e.g., signals from a network). In order to attach information handling system 601 to another computer system to copy files over a network, LAN card 630 is coupled to PCI bus 625 and to PCI-to-ISA bridge 635. Similarly, to connect computer system 601 to an ISP to connect to the Internet using a telephone line connection, modem 675 is connected to serial port 664 and PCI-to-ISA Bridge 635.

While the computer system described in FIG. 6 is capable of executing the invention described herein, this computer system is simply one example of a computer system. Those skilled in the art will appreciate that many other computer system designs are capable of performing the invention described herein.

One of the preferred implementations of the invention is an application, namely, a set of instructions (program code) in a code module which can, for example, be resident in the random access memory of the computer. Until required by the computer, the set of instructions can be stored in another computer memory, for example, on a hard disk drive, or in removable storage such as an optical disk (for eventual use in a CD ROM) or floppy disk (for eventual use in a floppy disk drive), or downloaded via the Internet or other computer network. Thus, the present invention can be implemented as a computer program stored on a computer readable medium and executable by a digital processing apparatus to perform operations to display data. In addition, although the various methods described are conveniently implemented in a general purpose computer selectively activated or reconfigured by software, one of ordinary skill in the art would also recognize that such methods can be carried out in hardware, in firmware, or in more specialized apparatus constructed to perform the required method steps.

While the embodiments of the invention disclosed herein are presently considered to be preferred, various changes and modifications can be made without departing from the spirit and scope of the invention. For example, the designer can adjust settings based on constraints such as number of electrical violations, available area, available CPU time, power budget, or the like, and trade off the quality of solution with run time. The scope of the invention is indicated in the appended claims, and all changes that come within the meaning and range of equivalents are intended to be embraced therein.

What is claimed is:

1. A method for correcting electrical violations, the method comprising:
examining a plurality of nets for at least one electrical violation in a sequential order of a first output-to-input traversal; and
determining a net correction for each net of the plurality of nets having an electrical violation prior to examining a next net in the sequential order of the first output-to-input traversal.

2. The method of claim 1, further comprising:
applying the net correction to each net of the plurality of nets having an electrical violation.

3. The method of claim 1, further comprising:
determining a net adjustment in each net of the plurality of nets having no electrical violation prior to examining a next net in the sequential order of the first output-to-input traversal.

4. The method of claim 1, further comprising:
examining the plurality of nets for at least one electrical violation in the sequential order of a second output-to-input traversal.

5. The method of claim 1, wherein the net correction is selected from the group consisting of gate resizing, buffering, and local resynthesis

6. The method of claim 1, wherein the preferred order of net corrections from most to least favored are gate resizing, buffering, and local resynthesis.

7. An information handling system comprising:
a processor;
a memory coupled to said processor to store instructions executable by a digital processing apparatus to perform operations to correct electrical violations, the operations comprising:
examining a plurality of nets for at least one electrical violation in a sequential order of a first output-to-input traversal; and
determining a net correction for each net of the plurality of nets having an electrical violation prior to examining a next net in the sequential order of the first output-to-input traversal.

8. The system of claim 7, further comprising:
applying the net correction to each net of the plurality of nets having an electrical violation.

9. The system of claim 7, further comprising:
determining a net adjustment in each net of the plurality of nets having no electrical violation prior to examining a next net in the sequential order of the first output-to-input traversal.

10. The system of claim 7, further comprising:
examining the plurality of nets for at least one electrical violation in the sequential order of a second output-to-input traversal.

11. The system of claim 7, wherein the net correction is selected from the group consisting of gate resizing, buffering, and local resynthesis.

12. The system of claim 7, wherein the preferred order of net corrections from most to least favored are gate resizing, buffering, and local resynthesis.

13. A computer program product in a computer usable medium for correcting electrical violations, comprising:
computer program code for examining a plurality of nets for at least one electrical violation in a sequential order of a first output-to-input traversal; and
computer program code for determining a net correction for each net of the plurality of nets having an electrical violation prior to examining a next net in the sequential order of the first output-to-input traversal.

14. The product of claim 13, further comprising:
computer program code for applying the net correction to each net of the plurality of nets having an electrical violation.

15. The product of claim 13, further comprising:
computer program code for determining a net adjustment in each net of the plurality of nets having no electrical violation prior to examining a next net in the sequential order of the first output-to-input traversal.

16. The product of claim 13, further comprising:
computer program code for examining the plurality of nets for at least one electrical violation in the sequential order of a second output-to-input traversal.

17. The product of claim 13, wherein the net correction is selected from the group consisting of gate resizing, buffering, and local resynthesis.

18. The product of claim 13, wherein the preferred order of net corrections from most to least favored are gate resizing, buffering, and local resynthesis.

19. The product of claim 13, wherein:
the computer program code for examining a plurality of nets includes computer program code for examining a first net for an electrical violation;
the computer program code for determining a net correction includes computer program code for determining a net correction for the first net when the first net has an electrical violation; and
the computer program code for examining a plurality of nets further includes computer program code for examining a second net for an electrical violation; and
the second net is upstream from the first net.

20. The product of claim 19, further comprising:
computer program code for applying the net correction to the first net prior to the examining the second net for an electrical violation.
